(19) United States
(12) Patent Application Publication
(10) Pub. No.: US 2008/0115473 A1
(43) Pub. Date: May 22, 2008

(54) COMPUTER AIR FILTER DEVICE

(76) Inventor: William Todd Miller, Jesup, GA (US)

Correspondence Address: WOOD AND EISENBERG, PLLC, 6911 RICHMOND HIGHWAY, SUITE 403, Alexandria, VA, 22306, US

(21) Appl. No.: 11/560,667

(22) Filed: Nov. 16, 2006

(51) Int. Cl. B01D 50/00; B01D 59/50

(52) U.S. Cl. 55/385.6

(57) ABSTRACT

A computer air filter device. The computer air filter device is made up of an air filter having first and second opposite sides, and a plurality of magnets attached to at least one side of the air filter. During normal use the dust filtering device is placed over an air intake grill located in a computer housing made of ferrous metal such that the plurality of magnets holds the air filter over the air intake grill to filter air prior to the air traveling through the air filter grill.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

This invention relates to a filtering device for use on computer apparatus to reduce the accumulation of dust and dirt inside the computer. More specifically, the invention is directed to a computer air filter device to help keep the interior of a computer free of dust and dirt.

### BACKGROUND OF THE INVENTION

Computers typically comprise a housing in which circuit boards and electrical components are housed. During normal use the electrical components often get hot. It is important that hot electrical components do not overheat. Components that overheat may malfunction and in extreme cases might result in a fire.

Components typically lose heat by convection and/or radiation. Effective heat dissipation typically requires clean surfaces and good local air circulation. Since heat loss heats up the internal air inside the computer housing, it is necessary to replace the internal air with outside air either continuously or periodically, a task that is typically performed by a fan installed in the computer housing.

An unfortunate consequence of using air to cool computer parts is that air brought into the computer housing contains particulate matter such as dust. Dust layers may form on the computer parts. Dust covered computer parts lose heat at a lower rate than dust-free computer parts. Thus, there is a need to provide dust free air to cool the computer parts located in a computer's housing.

A review of the prior art follows.

U.S. Pat. No. 4,889,542, issued Dec. 26, 1989 to Hayes, describes a filter panel that is adhesively attached to the outside of computer and disk drive housings to cover the air intake grids used to draw air into the housing by a draft from a cooling fan in the housing, with the filter device of a porous permeable reticulated flexible polyester polymeric foam about ¼ inch thick with permanently adhered adhesive strips on the back side to removably attach the foam over the air intake opening, with a frame hinged to fit over disk drive slot spring to seal over opening. The filter panel is disposable and may be easily removed and discarded when the dust and dirt accumulated into the filter begins to reduce the airflow through the filter into the cabinet.

U.S. Patent Publication No. 20020163789, published Nov. 7, 2002 to Yu-che et al., describes a dust filtering apparatus for a computer system comprising computer housing and a dust filtering apparatus, wherein the computer housing is used to accommodate the computer components of the computer system. The computer housing has a panel. The dust filtering apparatus has an area approximated to the area of that panel. The dust filtering apparatus comprises a first dust filtering member and a second dust-filtering member. The first dust filtering member and the second dust-filtering member of the dust filtering apparatus are bonded together. The dust filtering apparatus is magnetically attached to the panel of the computer housing and thereby forms a seamless protection to prevent computer components from being contamination by dust particles.

U.S. Pat. No. 5,600,090, issued Feb. 4, 1997 to Morris, describes a computer dust filter cover comprising an open cell synthetic foam sheet formed into a bonnet-like arrangement by an elastic strap. The cover is readily attached and removed from the computer-housing front or side panels to cover the disc slots while the computer is in use and without interfering with the use of the computer. The cover can remain in place when the computer is not in use to protect the interior of the housing and parts therein from contamination by particulates at all times.

U.S. Pat. No. 6,767,379, issued Jul. 27, 2004 to Jones, describes a computer box filter system for a computer box including a hollow, unshaped frame assembly that selectively attaches to a computer box. The frame assembly includes a plurality of holes formed on its inside surface which are aligned and registered with holes formed on the sides of the computer box. Disposed inside the frame assembly is a replaceable air filter. In one embodiment, the system includes a closeable door cover that attaches to the frame assembly and selectively closes over the entire front surface of the computer box. The frame assembly includes an extending lip that properly aligns the lower section of the frame assembly on the computer box so that the edges of the door cover may be pressed against the edges of the frame assembly during use to form a seal around the front surface.

### SUMMARY OF THE INVENTION

A computer air filter device. The computer air filter device is made up of an air filter having first and second opposite sides, and a plurality of magnets attached to at least one side of the air filter. During normal use the dust filtering device is placed over an air intake grill located in a computer housing made of ferrous metal such that the plurality of magnets holds the air filter over the air intake grill to filter air prior to the air traveling through the air filter grill.

### BRIEF DESCRIPTION OF THE DRAWINGS

FIG. 1 is an environmental view of a computer air filter device being used to filter air prior to entering a computer's housing according to the present invention.

FIG. 2 is a planer view of the underside of the computer air filter device shown in FIG. 1.

FIG. 3A is a planer view of the underside of a computer air filter device according to the present invention.

FIG. 3B is a planer view of the underside of a computer air filter device according to the present invention.

FIG. 4 is a planer view of the underside of a computer air filter device according to the present invention.

FIG. 5 is an exploded view of the computer air filter device shown in FIG. 1.

FIG. 6 is a partial side view of the computer air filter device shown in FIG. 1.

FIG. 7 is an environmental view of a computer air filter device according to the present invention.

FIG. 8 shows the outline of a letter representing discrete areas of high density in the computer air filter device according to the present invention.

Similar reference characters denote corresponding features consistently throughout the attached drawings.

### DETAILED DESCRIPTION OF THE INVENTION

This invention is directed to a filtering device for use on computer apparatus to reduce the accumulation of dust and dirt inside the computer. More specifically, the invention is directed to a computer air filter device to help keep the interior of a computer free of dust and dirt. The computer air filter device of the present invention is denoted generally by the numeric label “100”.

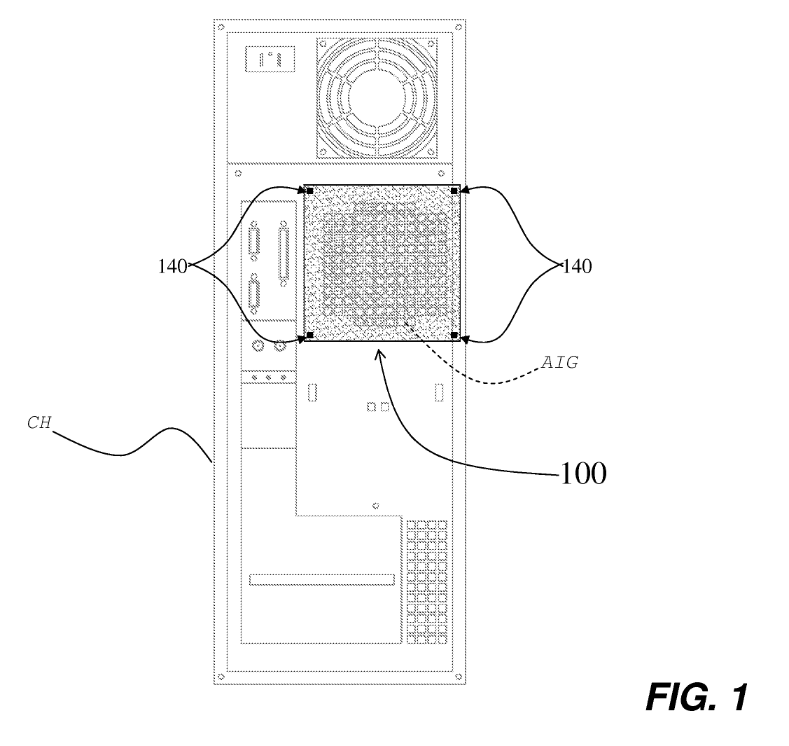

Referring to the FIGURES in general, the computer air filter device 100 comprises an air filter 120, and a plurality of magnets 140. The air filter 120 includes first and second opposite sides 160 and 180, respectively. The plurality of magnets 140 is attached to one side of the air filter 120. During normal use the computer air filter device 100 is placed over an air intake grill AIG located in a computer housing CH (see FIG. 1). However, it should be understood that the air filter device 100 can be placed over any kind of air intake grill, such as an air-intake grill feeding air to a computer's power supply; the only consideration is that an appropriate metallic material is located on or proximate to the air intake grill to allow magnets 140 to be attached thereto.

The magnets 140 are positioned around an air intake grill AIG. The flow of air into and through the air intake grill AIG ensures that the air filter 120 is held firmly against the outside of the computer's air intake grill AIG. Since magnets typically stick to ferrous materials it follows that the computer air filter device 100 of the present invention is best attached to computer exterior made up of ferrous material.

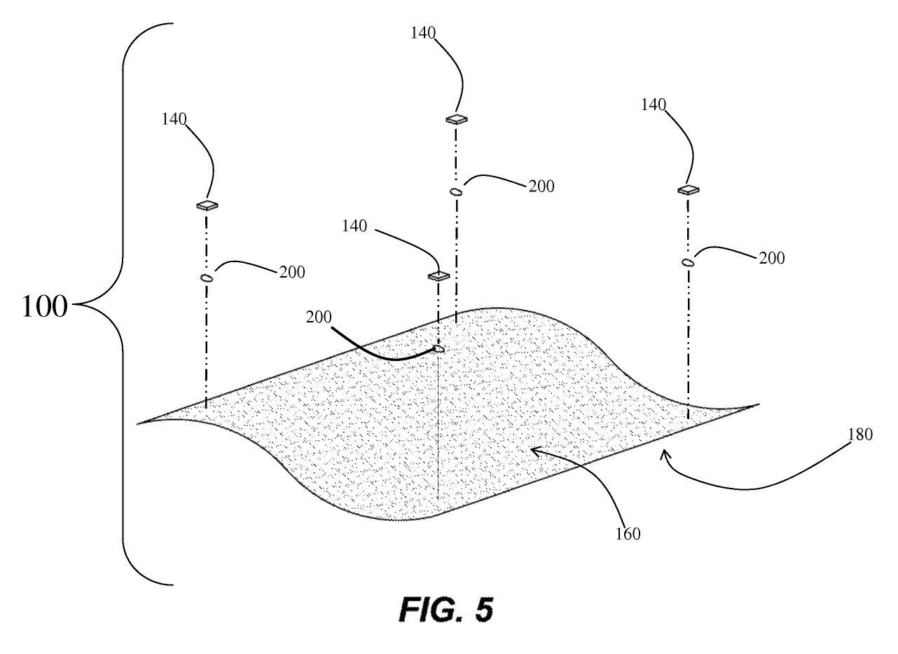

In a preferred embodiment, each magnet 140 is glued to one side of the air filter 120. In one aspect of the invention, the computer air filter device 100 is, in part, a laminate structure made up of an air filter layer 120 and a magnetic layer (provided by anyone of the magnets 140) with a layer of adhesive 200 therebetween (see FIG. 6), i.e., in this aspect of the invention each magnet 140 is adhered to one side of the air filter 120 (first side 160 or second side 180) by means of an intervening layer of adhesive 200. The adhesive can be any suitable adhesive able to glue metal or metal-like material to a layer of fabric. For example, each of the magnets may be glued to the air filter 120 using a glue containing cyanoacrylate such as KRAZY™ Instant Glue supplied by Elmer's Products, Inc., Columbus, Ohio 43215-3799. Adhesive compositions based on 2-cyanoacrylates may be used as described in U.S. Pat. No. 3,968,186, issued Jul. 6, 1976 to Tomaschek et al., which is incorporated herein by reference in its entirety.

Referring to FIG. 1, which shows an environmental view of the computer air filter device 100 fitted over an air intake grill AIG at the rear of a computer housing CH. The computer air filter device 100 filters air of dust just prior to passing through the air intake grill AIG. Without the computer air filter device 100, unfiltered air would be sucked in through the air intake grill AIG.

The air filter 120 can be made of any suitable materials such as, but not limited to, an open cell synthetic foam sheet as described in U.S. Pat. No. 5,600,090, issued Feb. 4, 1997 to Morris. Morris '090 is incorporated by reference herein in its entirety. For example, the air filter 120 can be made of porous and permeable reticulated flexible polymeric foam having three-dimensional skeletal strands, a pore size in the range of about 40 to about 90 pores per lineal inch, and a thickness in the range of about 3/16 inch to about 5/16 inch.

Alternatively, the air filter 120 can take the form of an air-permeable sheet having low airflow resistance as described in U.S. Pat. No. 6,936,094, but with the deodorizing function described therein regarded as optional. U.S. Pat. No. 6,936,094 is incorporated herein by reference in its entirety.

The air filter 120 may comprise a plurality of fibers such as a batt of non-woven fibers as described in U.S. Pat. No. 6,716,266. Examples of suitable fibers include polyester, wool, cotton, arylamides or arylimides.

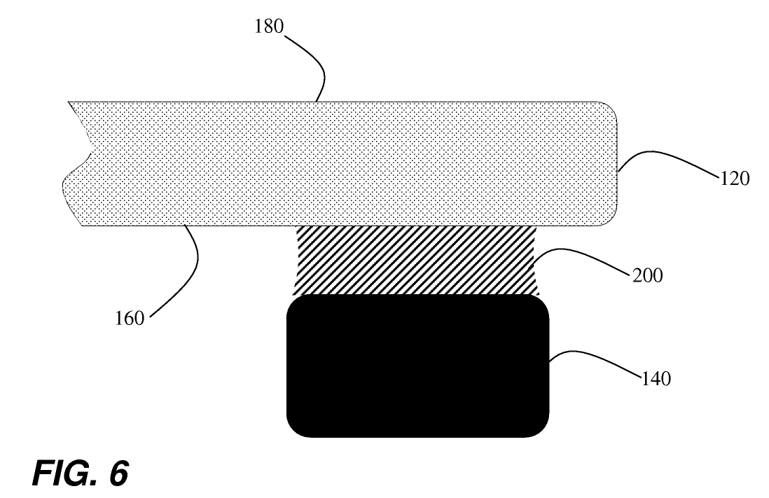

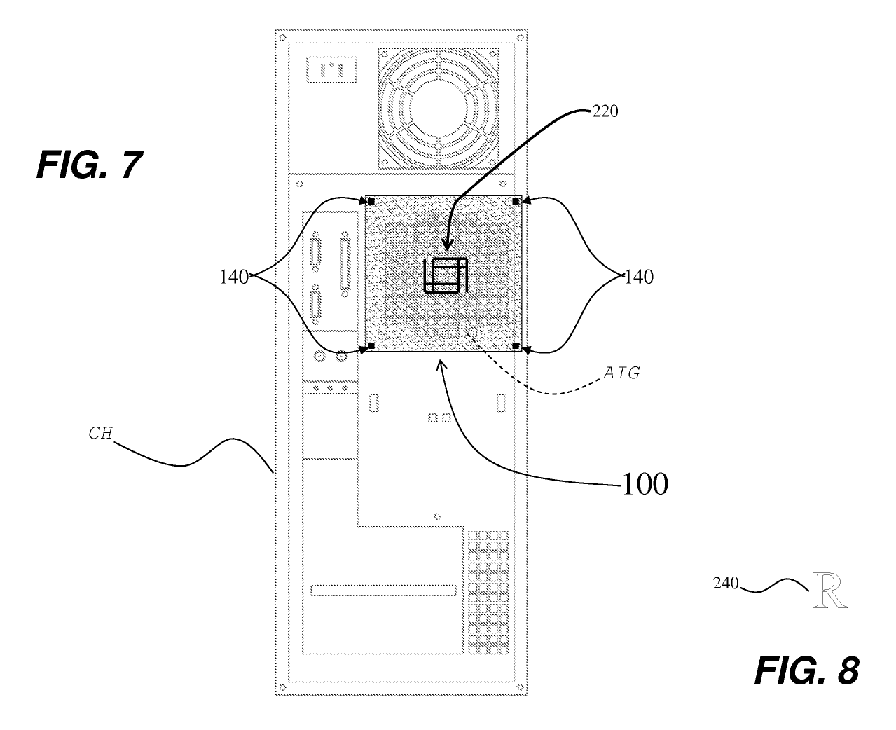

A use-indicator may be provided as an integral part of the air filter 120 to indicate when the filtering device 100 should be replaced. The use-indicator might take the form of a compressed section of the air filter 120. Compression increases density as described in U.S. Pat. No. 6,716,266 (the '266 patent is incorporated herein by reference in its entirety). As the regions of greater density will have a reduced airflow therethrough, they will tend to pick up less dust. Over time dust will collect at the regions of higher density to form visible symbols, words or letters, e.g., a symbol 220 as shown in FIG. 7. Such usage symbols, words or letters can be expressed in outline thereby minimizing potential interference to airflow across the air filter 120. Specifically, the regions of high density could be limited to the outline of a letter 240 (e.g., the letter R as shown in FIG. 8) thus avoiding an airflow interference issue. The dust collected by the filter will make such words or symbols more visible hence giving an indication to the computer owner or user that the filter device 100 needs to be cleaned or replaced.

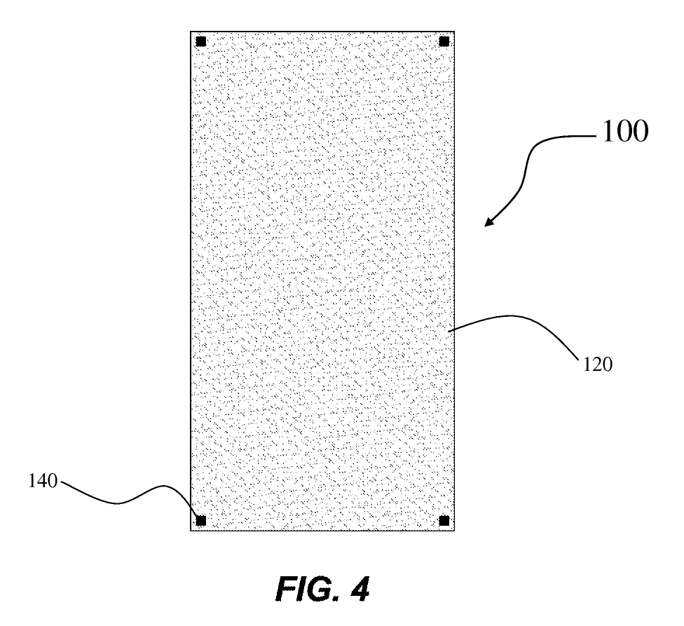

The magnets 140 are attached by adhesive 200 to the air filter 120 (see FIGS. 5 and 6). The air filter 120 can be any suitable air filter which does not substantially interfere with the ability of a computer's fan to bring air through a computer's air intake grill AIG.

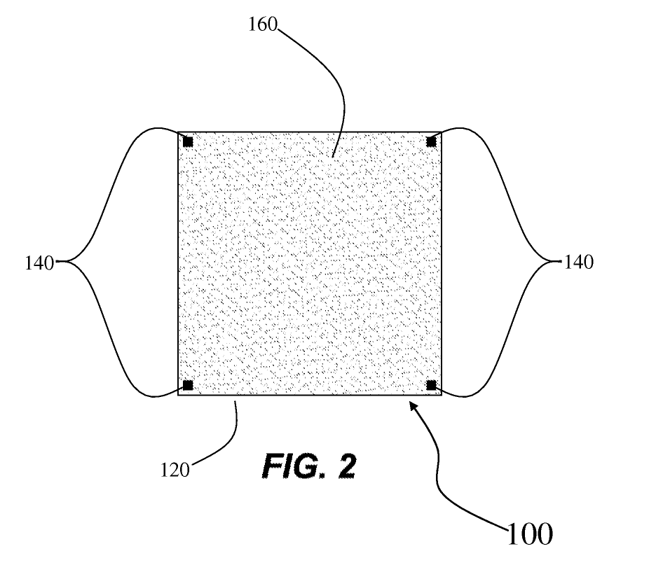

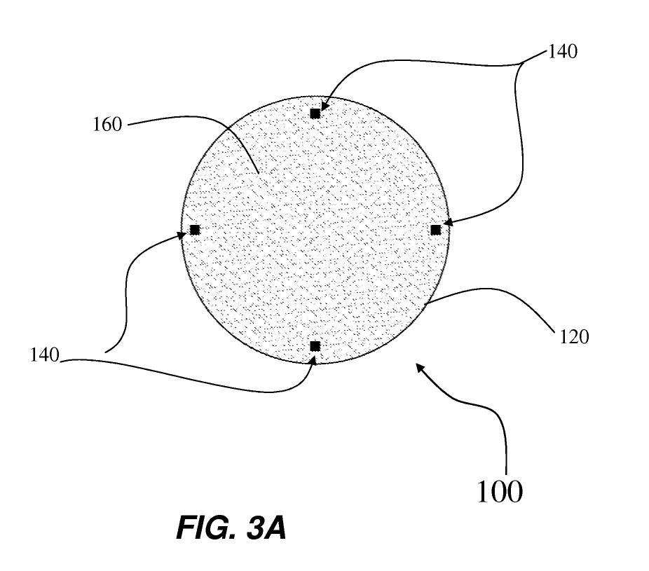

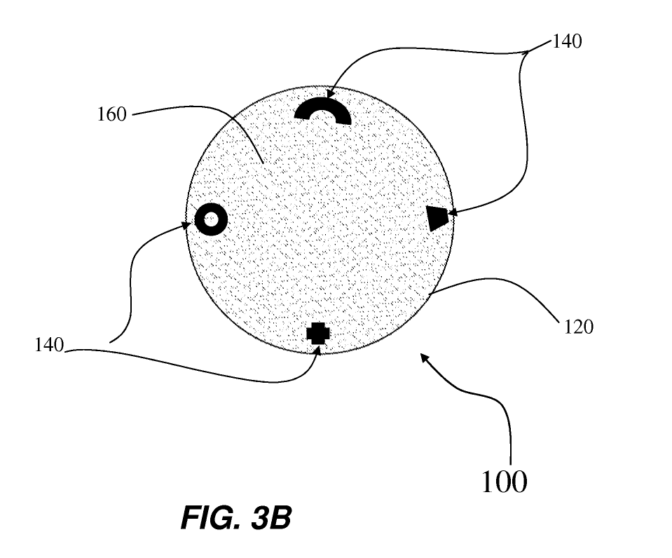

In FIG. 2, which shows a planar view of the computer air filter device 100, the air filter 120 has a generally square shape with magnets 140 positioned at each corner. It should be understood, however, that the air filter 120 is not limited to a particular shape. For example, in FIG. 3A the air filter has a generally circular shape and in FIG. 4 a rectangular shape. More specifically, the air filter 120 can be any shape such as, but not limited to, an irregular polygonal shape or a regular polygonal shape (e.g., a regular octagonal or hexagonal shape). The magnets 140 have a square shape in, for example, FIG. 3A. However, the shape of the magnets 140 can vary as shown in FIG. 3B.

It is to be understood that the present invention is not limited to the embodiments described above, but encompasses any and all embodiments within the scope of the following claims.

I claim:

1. A computer air filter device, comprising:
an air filter having first and second opposite sides; and
a plurality of magnets attached to at least one side of said air filter,
wherein during normal use said dust filtering device is placed over an air intake grill located in a computer housing made of ferrous metal such that said plurality of magnets holds said air filter over the air intake grill to filter air prior to the air traveling through the air filter grill.

2. The computer air filter device according to claim 1, wherein each of said plurality of magnets are attached to said first opposite side of said air filter by a layer of adhesive placed between each of said plurality of magnets and said first opposite side of said air filter.

3. The computer air filter device according to claim 1, wherein said air filter is made of porous and permeable reticulated flexible polymeric foam having three-dimensional skeletal strands, a pore size in the range of about 40 to about 90 pores per lineal inch, and has a thickness in the range of about 3/16 inch to about 5/16 inch.
